(19) United States
(12) Patent Application Publication
(10) Pub. No.: US 2005/0206823 A1
(43) Pub. Date: Sep. 22, 2005

(54) In-plane switching mode liquid crystal display

(76) Inventors: Chien-Ting Lai, Miao-Li (TW); Jia-Pang Pang, Miao-Li (TW); Chueh-Ju Chen, Miao-Li (TW)

Correspondence Address: WEI TE CHUNG;FOXCONN INTERNATIONAL, INC., 1650 MEMOREX DRIVE, SANTA CLARA, CA, 95050, US

(21) Appl. No.: 11/028,126

(22) Filed: Dec. 31, 2004

(30) Foreign Application Priority Data
Mar. 20, 2004 (CN) 2004100266143

(51) Int. Cl. G02F 1/1343

(52) U.S. Cl. 349/141

(57) ABSTRACT

An IPS mode LCD (100) includes a first substrate (111), a second substrate (114), a layer of liquid crystal molecules (116) held therebetween, a plurality of gate lines (130) arranged on the second substrate, an insulative layer (120) formed on surfaces of the second substrate and the gate lines, a plurality of data lines (117) arranged on the insulative layer, a passivation layer (118) formed on surfaces of the insulative layer and the data lines, and a plurality of pixel electrodes (127) and common electrodes (115) arranged on the passivation layer. The common electrodes partly overlap corresponding data lines. Back light transmitting from the second substrate toward the first substrate is blocked by the data lines and only parts of the common electrodes. Thus an aperture ratio of the IPS mode LCD is raised, and a brightness and display quality of the IPS mode LCD is enhanced.

### BACKGROUND OF THE INVENTION

1. Field of the Invention

The present invention relates to liquid crystal displays (LCDs), and particularly to an in-plane switching (IPS) mode LCD.

2. Description of the Prior Art

In general, LCDs have two main advantages in comparison with cathode ray tube (CRT) displays: LCDs are thin, and have low power consumption. It has been said that LCDs might one day completely replace CRT displays, and LCDs have aroused great interest in many industries in recent times.

LCDs generally provide a narrower viewing angle compared with CRT displays. Scientists and engineers have taken great pains to widen the viewing angle of LCDs. In particular, in recent years, IPS mode LCDs have been flourishing. An IPS mode LCD is based on a principle different from principles involved in other modes such as Twisted Nematic (TN) mode and Super Twisted Nematic (STN) mode. LCDs using these other modes are hereinafter collectively referred to “usual” LCDs.

In a usual LCD, an electric field is generated perpendicular to a principal surface of a substrate. When the electric field is selectively and locally applied on a liquid crystal layer, liquid crystal molecules in the liquid crystal layer are uniformly oriented perpendicular to the principal surface. Coexistence of these aligned/oriented liquid crystal molecules with unaligned/unoriented liquid crystal molecules provides the visual contrast between black and white on the usual LCD.

Compare this with the IPS mode LCD, which provides said contrast by horizontally and locally applying a lateral electric field generated by a pair of electrodes positioned on a same substrate. That is, the liquid crystal molecules of the liquid crystal layer are locally aligned/oriented along the parallel electric field parallel to the substrate. Consequently, each liquid crystal molecule is easily rotated in a plane due to the parallel field.

However, because the electrodes are positioned on the same substrate, an aperture ratio of such IPS mode LCD is lower, which results in a lower brightness of the IPS mode LCD.

In order to raise the aperture ratio and brightness, Sharp Corporation has developed a technology called ultra high aperture ratio (UHA), which can be traced back to a technology known as super high aperture ratio (SHA). In these technologies, a polyester insulative layer is formed on data lines of the LCD, and then thin film transistor (TFT) lines are formed on the insulative layer. The material of the data lines in SHA is tantalum, and the material of the data lines in UHA is aluminum. Generally, the higher the resolution of the LCD, the larger the areas covered by the data lines. Thus in a high resolution LCD, much back light is blocked by the data lines, which lowers the aperture ratio and brightness of the LCD. To solve this problem, a width of the data lines is usually reduced. However, reducing the width of the data lines can raise their electrical resistance. It is difficult to obtain a satisfactory balance providing both a high aperture ratio and low electrical resistance.

FIG. 2 is a cross-sectional view of part of a conventional IPS mode LCD 1. The IPS mode LCD 1 is a transmissive LCD, and includes: a first substrate 11; an opposite second substrate 14; a plurality of liquid crystal molecules 16 held between the substrates 11, 14; a plurality of common electrodes 15 and a transparent insulative layer 20 formed on an inner surface of the second substrate 14 in sequence; a plurality of pixel electrodes 27 and data lines 17 formed on the insulative layer 20; a passivation layer 18 formed on surfaces of the pixel electrodes 27, data lines 17 and insulative layer 20; a second alignment layer 19 formed on the passivation layer 18 and being adjacent to the liquid crystal molecules 16; and a color filter layer 12 and a first alignment layer 13 formed on an inner surface (not labeled) of the first substrate 11 in sequence. The common electrodes 15 and the pixel electrodes 27 are arranged in pairs at intervals in order to generate a lateral electric field 25, with the common electrodes 15 and the data lines 17 also being arranged at intervals. Back light transmitting from the second substrate 14 toward the first substrate 11 is blocked by the common electrodes 15 and the data lines 17. The back light transmitting out from the first substrate 11 is reduced, which reduces a brightness of the IPS mode LCD 1.

A new IPS mode LCD which overcomes the above-mentioned disadvantages is desired.

### SUMMARY OF THE INVENTION

An object of the present invention is to provide an IPS mode LCD having both a high aperture ratio and a high quality display.

To achieve the above object, an IPS mode LCD of the present invention includes a first substrate, a second substrate, a liquid crystal layer held therebetween, a plurality of gate lines arranged on the second substrate, an insulative layer formed on surfaces of the second substrate and the gate lines, a plurality of data lines arranged on the insulative layer, a passivation layer formed on surfaces of the insulative layer and the data lines, and a plurality of pixel electrodes and common electrodes arranged on the passivation layer. The common electrodes partly overlap corresponding data lines.

The advantage of the invention is that back light transmitting from the second substrate toward the first substrate is blocked by the data lines and only parts of the common electrodes. Thus an aperture ratio of the IPS mode LCD is raised. More back light emits out from the first substrate, and a brightness and display quality of the IPS mode LCD is enhanced.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic, cross-sectional view of a part of an IPS mode LCD in accordance with a preferred embodiment of the present invention, showing a data line partly overlapped by a common electrode; and

FIG. 2 is a schematic, cross-sectional view of a part of a conventional IPS mode LCD, showing a data line completely isolated spatially from a common electrode.

### DETAILED DESCRIPTION OF THE PRESENT INVENTION

Hereinafter, a preferred embodiment of the present invention will be explained in more detail with reference to the accompanying drawing thereof.

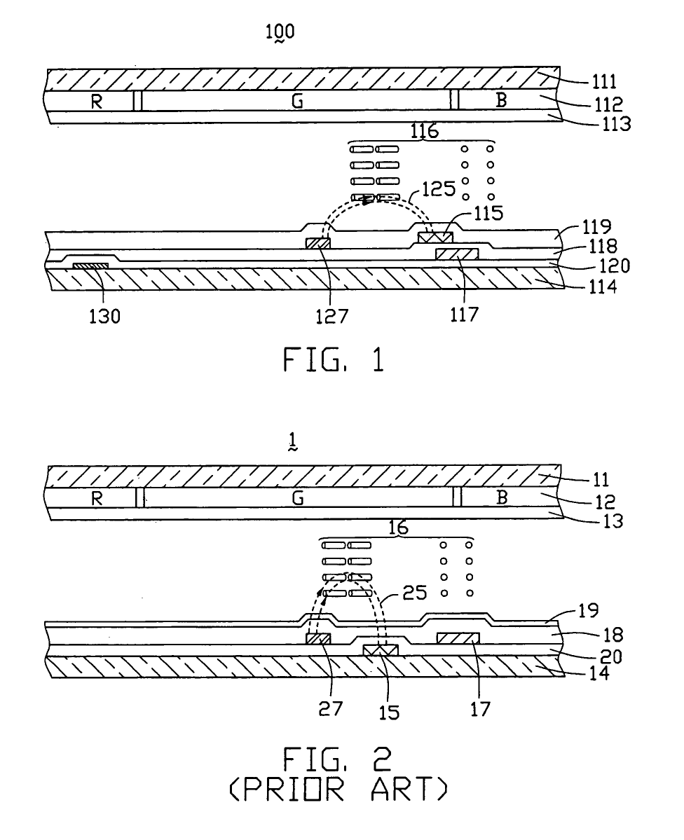

Referring to FIG. 1, an IPS mode LCD 100 according to the present invention comprises a first substrate 111, an opposite second substrate 114, and a layer of liquid crystal molecules 116 held between the first and second substrates 111, 114.

The IPS mode LCD 100 further comprises a plurality of gate lines 130 arranged on the second substrate 114, an insulative layer 120 formed on surfaces of the second substrate 114 and the gate lines 130, a plurality of data lines 117 arranged on the insulative layer 120, a passivation layer 118 formed on surfaces of the insulative layer 120 and the data lines 117 in order to protect the data lines 117, a plurality of pixel electrodes 127 and common electrodes 115 arranged on the passivation layer 118, and a second alignment layer 119 formed on surfaces of the passivation layer 118, the pixel electrodes 127 and the common electrodes 115 in order to align the liquid crystal molecules 116.

The IPS mode LCD 100 still further comprises a color filter layer 112 and a first alignment layer 113 sequentially arranged adjacent an underside of the first substrate 111.

Each of the pixel electrodes 127 and common electrodes 115 includes a conductive film (not shown) thereon. The pixel electrodes 127 and common electrodes 115 are bar-shaped, and are arranged in parallel pairs at regular intervals in order to generate lateral electric fields 125. The common electrodes 115 partly overlap the data lines 117. The pixel electrodes 127 and common electrodes 115 are respectively made of a metal, such as gold, silver, or copper. The conductive film is made of a metal, or a transparent oxide such as indium zinc oxide (IZO) or indium tin oxide (ITO). The data lines 117 are made of a metal.

In operation, because the common electrodes 115 partly overlap the data lines 117, back light transmitting from the second substrate 114 toward the first substrate 111 is blocked by the data lines 117 and only parts of the common electrodes 115. That is, an aperture ratio of the IPS mode LCD 100 is raised. More back light emits out from the first substrate 111, and a brightness and display quality of the IPS mode LCD 100 is enhanced.

While the present invention has been described with reference to a particular embodiment, the description is illustrative of the invention and is not to be construed as limiting the invention. Therefore, various modifications of the described embodiments can be made by those skilled in the art without departing from the true spirit and scope of the invention as defined by the appended claims. In particular, the pixel electrodes 127 and common electrodes 115 may be other than bar-shaped; for example, they may be S-shaped or zigzagged. Further, the pixel electrodes 127 and common electrodes 115 may alternatively be made of a transparent conductor, such as indium zinc oxide (IZO) or indium tin oxide (ITO).

1. An in-plane switching mode liquid crystal display, comprising:
a first substrate;
a second substrate;
a liquid crystal layer held between the first substrate and the second substrate;
a plurality of gate lines arranged on the second substrate;
an insulative layer formed on surfaces of the second substrate and the gate lines;
a plurality of data lines arranged on the insulative layer;
a passivation layer formed on surfaces of the insulative layer and the data lines; and
a plurality of pixel electrodes and common electrodes arranged on the passivation layer;
wherein the common electrodes partly overlap corresponding data lines.

2. The in-plane switching mode liquid crystal display of claim 1, wherein each of the common electrodes includes a conductive film thereon.

3. The in-plane switching mode liquid crystal display of claim 2, wherein the conductive film is made of metal.

4. The in-plane switching mode liquid crystal display of claim 2, wherein the conductive film is made of indium zinc oxide.

5. The in-plane switching mode liquid crystal display of claim 2, wherein the conductive film is made of indium tin oxide.

6. The in-plane switching mode liquid crystal display of claim 1, wherein the pixel electrodes and common electrodes are bar-shaped.

7. The in-plane switching mode liquid crystal display of claim 1, wherein the pixel electrodes and common electrodes are S-shaped.

8. The in-plane switching mode liquid crystal display of claim 1, wherein the pixel electrodes and common electrodes are zigzagged.

9. The in-plane switching mode liquid crystal display of claim 1, wherein the common electrodes are made of metal.

10. The in-plane switching mode liquid crystal display of claim 1, wherein the pixel electrodes are made of a transparent conductor.

11. The in-plane switching mode liquid crystal display of claim 1, wherein the data lines are made of metal.

12. An in-plane switching mode liquid crystal display, comprising:
a first substrate;
a second substrate;
a liquid crystal layer held between the first substrate and the second substrate;
a plurality of gate lines arranged on the second substrate;
an insulative layer formed on surfaces of the second substrate and the gate lines;
a plurality of data lines arranged on the insulative layer;
a passivation layer formed on surfaces of the insulative layer and the data lines; and
a plurality of pixel electrodes and common electrodes arranged on the passivation layer;
wherein the common electrodes partly overlie the data lines in a vertical direction.

13. An in-plane switching mode liquid crystal display, comprising:
a first substrate;
a second substrate;
a liquid crystal layer held between the first substrate and the second substrate;
an insulative layer formed on surfaces of the second substrate and the gate lines;
a plurality of data lines arranged on the insulative layer;
a plurality of pixel electrodes and common electrodes arranged above the passivation layer;
wherein the common electrodes partly overlie the data lines in a vertical direction.
